(19) United States
(12) Patent Application Publication
(10) Pub. No.: US 2018/0094651 A1
(43) Pub. Date: Apr. 5, 2018

(54) Torque Output Intensifier

(71) Applicant: Woodward, Inc., Fort Collins, CO (US)

(72) Inventors: Joseph H. Kim, Valencia, CA (US); Pawel A. Sobolewski, Arlington Heights, IL (US)

(21) Appl. No.: 15/286,262

(22) Filed: Oct. 5, 2016

(51) Int. Cl. F15B 15/12

(52) U.S. Cl. CPC F15B 15/125

(57) ABSTRACT

The subject matter of this specification can be embodied in, among other things, a rotary actuator that includes a housing defining an arcuate chamber comprising a cavity, a fluid port in fluid communication with the cavity, and an open end, the arcuate chamber following a portion of a first arc between a first end and a second proximal the open end, an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber, and a first bearing in contact with a first radial side of the piston relative to the radius of curvature at a contact point beyond the first arc.

### TECHNICAL FIELD

This invention relates to an actuator device and more particularly to a rotary piston type actuator device wherein the pistons of the rotor are moved by fluid under pressure.

### BACKGROUND

Rotary hydraulic actuators of various forms are currently used in industrial mechanical power conversion applications. This industrial usage is commonly for applications where continuous inertial loading is desired without the need for load holding for long durations, e.g. hours, without the use of an external fluid power supply. Aircraft flight control applications generally implement loaded positional holding, for example, in a failure mitigation mode, using substantially only the blocked fluid column to hold position.

In certain applications, such as primary flight controls used for aircraft operation, positional accuracy in load holding by rotary actuators is desired. Positional accuracy can be improved by minimizing internal leakage characteristics inherent to the design of rotary actuators. However, it can be difficult to provide leak-free performance in typical rotary hydraulic actuators, e.g., rotary “vane” or rotary “piston” type configurations.

### SUMMARY

In general, this document relates to rotary piston-type actuators.

In a first aspect, a rotary actuator includes a housing defining an arcuate chamber comprising a cavity, a fluid port in fluid communication with the cavity, and an open end, the arcuate chamber following a portion of a first arc between a first end and a second proximal the open end, an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber, and a first bearing in contact with a first radial side of the piston relative to the radius of curvature at a contact point beyond the first arc.

Various embodiments can include some, all, or none of the following features. The rotary actuator can include a second bearing in contact with a second radial side of the piston opposite the first radial side. The first radial side can be a radially upper side. The first radial side can be a radially lower side. The first bearing can be a roller bearing. The roller bearing can include a body portion configured to at least partly conform to the shape of the first radial side, and at least one end portion configured to at least partly conform to the shape of an axial side of the piston relative to the radius of curvature. The first housing can be formed as a one-piece housing.

In a second aspect, a method of rotary actuation includes providing a rotary actuator having a housing defining an arcuate chamber comprising a cavity, a fluid port in fluid communication with the cavity, and an open end, the arcuate chamber following a portion of a first arc between a first end and a second proximal the open end, an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber, and a first bearing in contact with a first radial side of the piston relative to the radius of curvature at a contact point beyond the first arc, applying, by the first bearing, a first radial force to the first radial side of the piston, applying pressurized fluid out the fluid port to urge the piston partially outward from the first pressure chamber, and urging the piston partially into the pressure chamber to urge pressurized fluid out the fluid port.

Various implementations can include some, all, or none of the following features. The rotary actuator can include a second bearing in contact with a second radial side of the piston opposite the first radial side, and the method include applying, by the second bearing, a second radial force to the first radial side of the piston. The first radial side can be a radially upper side, and wherein applying the first radial force to the first radial side of the piston can include constraining a radially outward force of the piston. The first radial side can be a radially lower side, and wherein applying the first radial force to the first radial side of the piston can include constraining a radially inward force of the piston. The first bearing can be a roller bearing. The roller bearing can be a body portion configured to at least partly conform to the shape of the first radial side, and at least one end portion configured to at least partly conform to the shape of an axial side of the piston relative to the radius of curvature. The method can include applying a first axial force to the axial side of the piston. Applying the first axial force can include constraining an axial force of the piston. The first housing can be formed as a one-piece housing.

The systems and techniques described here may provide one or more of the following advantages. First, a system can provide increased torque output for a rotary piston actuator. Second, the system can increase the range of actuation over which useable torque is available. Third, the system can reduce the amount of wear on piston seals. Fourth, the system can increase the lifespan of piston seals and other contacting components. Fifth, the system can reduce the amount of heat generated by friction within a rotary piston actuator. Sixth, the system can increase the durability of a rotary piston actuator.

The details of one or more implementations are set forth in the accompanying drawings and the description below. Other features and advantages will be apparent from the description and drawings, and from the claims.

### DESCRIPTION OF DRAWINGS

FIG. 1 is a perspective diagram that shows an example of a rotary piston actuator and torque intensifier.

FIG. 2A is a side diagram that shows an example of a rotary piston actuator and torque intensifier.

FIG. 2B is a sectional diagram that shows an example of a rotary piston actuator and torque intensifier.

FIGS. 3A and 3B are perspective diagrams that show an example of a rotary piston actuator and torque intensifier.

FIGS. 3C and 3D are side and perspective sectional diagrams that show an example of a rotary piston actuator and torque intensifier.

FIG. 4 is a sectional diagram that shows an example of a rotary piston actuator and another example of a torque intensifier.

FIG. 5 is a sectional diagram that shows an example of a rotary piston actuator and another example of a torque intensifier.

FIG. 6 is a flow diagram of an example process for using a rotary piston actuator having a torque output intensifier.

### DETAILED DESCRIPTION

This document describes devices for producing rotary motion. In particular, this document describes devices that can convert fluid displacement into rotary motion through the use of components more commonly used for producing linear motion, e.g., hydraulic or pneumatic linear cylinders. Vane-type rotary actuators are relatively compact devices used to convert fluid motion into rotary motion. Rotary vane actuators (RVA), however, generally use seals and component configurations that exhibit cross-vane leakage of the driving fluid. Such leakage can affect the range of applications in which such designs can be used. Some applications may require a rotary actuator to hold a rotational load in a selected position for a predetermined length of time, substantially without rotational movement, when the actuator's fluid ports are blocked. For example, some aircraft applications may require that an actuator hold a flap or other control surface that is under load (e.g., through wind resistance, gravity or g-forces) at a selected position when the actuator's fluid ports are blocked. Cross-vane leakage, however, can allow movement from the selected position.

Linear pistons use relatively mature sealing technology that exhibits well-understood dynamic operation and leakage characteristics that are generally better than rotary vane actuator type seals. Linear pistons, however, require additional mechanical components in order to adapt their linear motions to rotary motions. Such linear-to-rotary mechanisms are generally larger and heavier than rotary vane actuators that are capable of providing similar rotational actions, e.g., occupying a larger work envelope. Such linear-to-rotary mechanisms may also generally be installed in an orientation that is different from that of the load they are intended to drive, and therefore may provide their torque output indirectly, e.g., installed to push or pull a lever arm that is at a generally right angle to the axis of the axis of rotation of the lever arm. Such linear-to-rotary mechanisms may therefore need to be too large or heavy for use in some applications, such as aircraft control, where space and weight constraints may make such mechanisms impractical for use.

In general, rotary piston assemblies use curved pressure chambers and curved pistons to controllably push and pull the rotor arms of a rotor assembly about an axis. In use, certain embodiments of the rotary piston assemblies described herein can provide the positional holding characteristics generally associated with linear piston-type fluid actuators, to rotary applications, and can do so using the relatively more compact and lightweight envelopes generally associated with rotary vane actuators.

In general, the amount of torque that can be provided by rotary piston assembles can vary along the assemblies' ranges of motion. For example, a rotary piston can provide an approximately maximum amount of torque near a fully retracted position, and this amount of torque can decrease as the piston is actuated toward its extended limit of travel. In some embodiments, such decreases in torque capacity can be caused by forces acting upon the piston in directions that are not aligned with the piston's arc of travel. For example, forces acting radially or longitudinally upon the piston, rather than tangent to the piston's designed path of actuation, can cause the piston to bind within its cylinder which can increase frictional forces and wear, and possibly reduce available torque. This loss of torque can be at least partly reduced by redirecting such misaligned forces through the use of torque intensifiers, as will be described below.

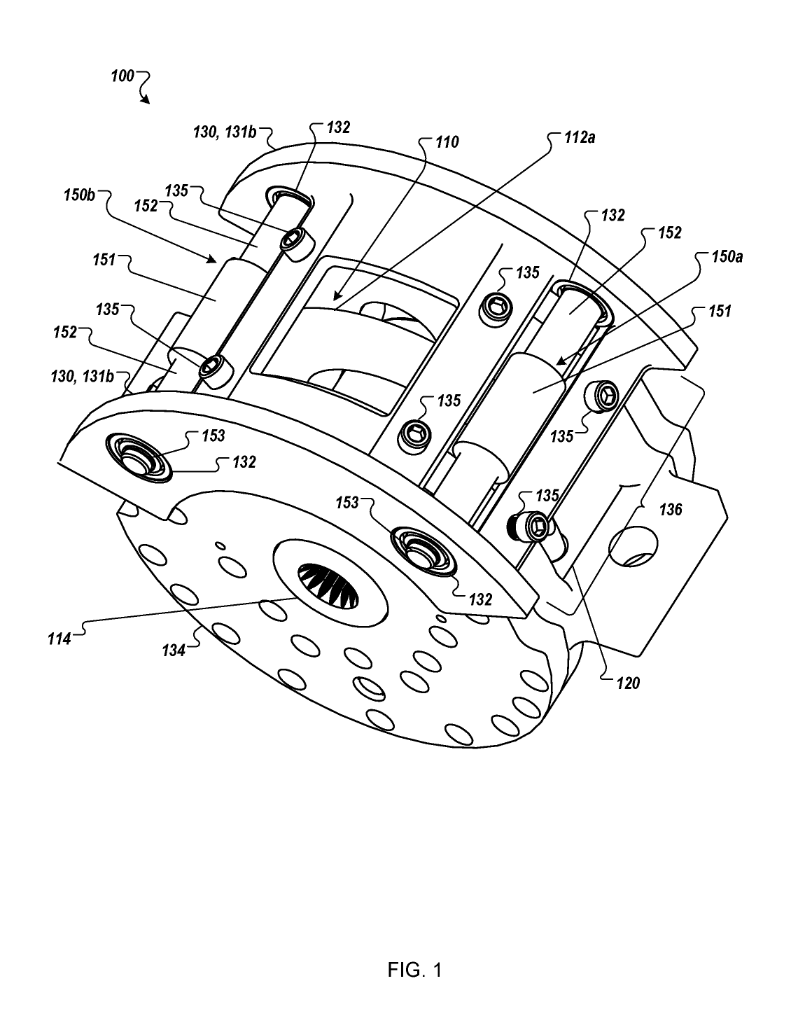

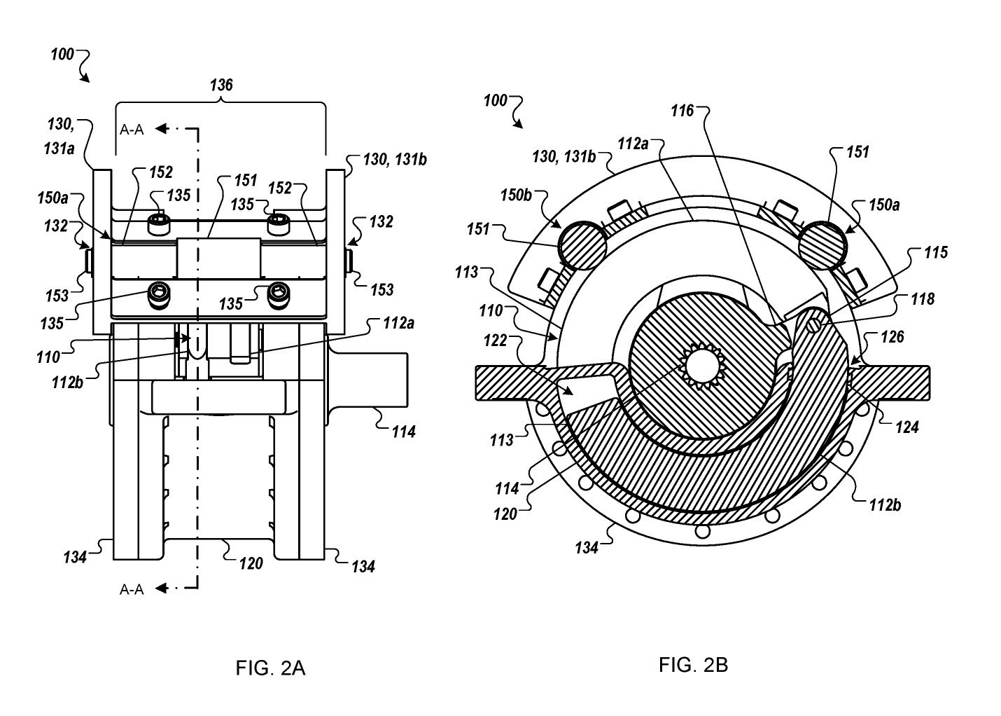

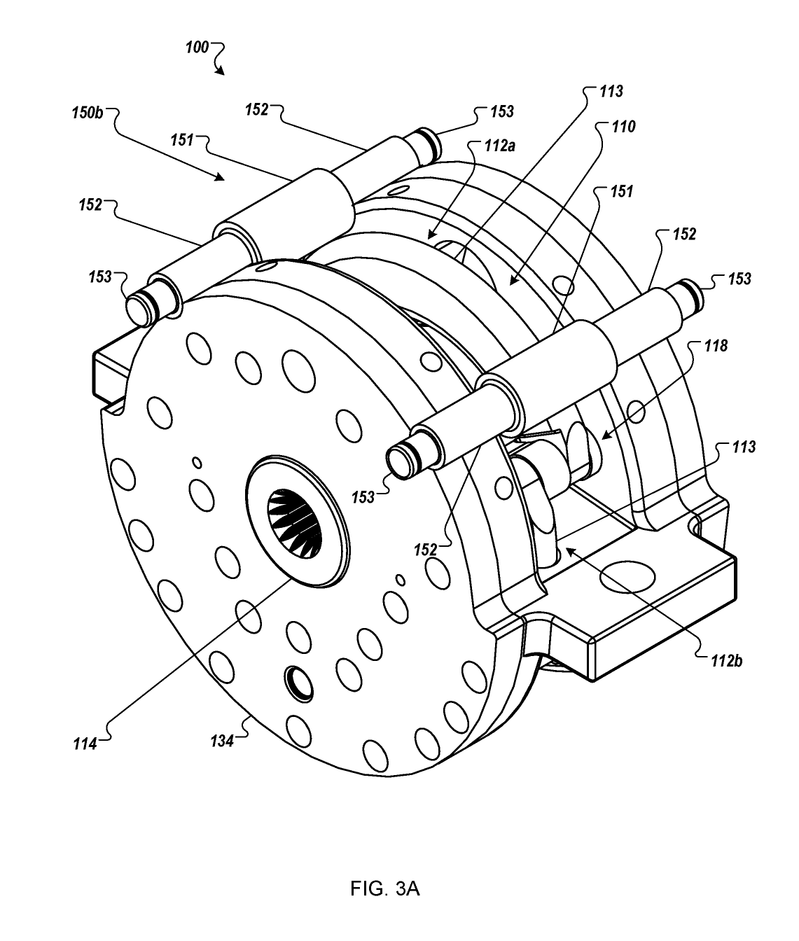

FIGS. 1, 2A, and 2B show various views of the components of an example rotary piston-type actuator 100. Referring to FIG. 1, a perspective view of the example rotary piston-type actuator 100 is shown. The actuator 100 includes a rotary piston assembly 110 and a pressure chamber assembly 120. The actuator 100 includes a first rotary piston 112a and a second rotary piston 112b (not visible in FIG. 1). In the example of actuator 100, the first rotary piston 112a is configured to rotate the rotary piston assembly 110 in a first direction, e.g., clockwise, and the second rotary piston 112b is configured to rotate the rotary piston assembly 110 in a second direction substantially opposite the first direction, e.g., counter-clockwise.

Referring now to FIG. 2B, which is a side cross sectional view of the example rotary piston-type actuator 100 taken along section A-A of FIG. 2A, the rotary piston assembly 110 includes a rotor shaft 114. A rotor arm 116 extends radially from the rotor shaft 114, the distal end of the rotor arm 116 including a bore (not shown) substantially aligned with the axis of the rotor shaft 114 and sized to accommodate a connector pin 118.

While the example actuator 100 includes a pair of the rotary pistons 112a and 112b, other embodiments can include greater and/or lesser numbers of cooperative and opposing rotary pistons. The rotary pistons 112a, 112b in the example actuator 100 of FIG. 2B are oriented substantially opposite each other in opposite rotational directions. In some embodiments, the actuator 100 can rotate the rotor shaft 114 nearly 180 degrees total.

In the example rotary piston assembly shown in FIG. 2B, each of the rotary pistons 112a, 112b includes a piston end 113 and one or more connector arms 115. The piston end 113 is formed to have a substantially smooth surface. Each of the connector arms 115 includes a bore aligned substantially parallel with the axis of the semi-circular arc of the corresponding rotary piston 112a, 112b, and sized to accommodate the connector pins 118.

Each of the rotary pistons 112a, 112b of the example assembly of FIG. 2B may be assembled to the rotor shaft 114 by aligning the connector arms 115 with the rotor arms 116 such that the bores (not shown) of the rotor arms 116 align with the bores. The connector pin 118 may then be inserted through the aligned bores to create hinged connections between the pistons 112a, 112b and the rotor shaft 114. The connector pin 118 is slightly longer than the aligned bores. In the example actuator 100, about the circumferential periphery of each end of the connector pin 118 that extends beyond the aligned bores is a circumferential recess (not shown) that can accommodate a retaining fastener (not shown), e.g., a snap ring or spiral ring.

In some implementations, the rotor shaft 114 can be connected to an external mechanism, such as an output shaft, in order to transfer the rotary motion of the actuator 100 to other mechanisms. In some embodiments, a bushing or bearing (not shown) can be fitted between the rotor shaft 114 and the axial bore of the pressure chamber assembly 120.

The illustrated examples show the rotary piston 112b inserted into a corresponding pressure chamber 122 formed as an arcuate cavity in the pressure chamber assembly 120. The rotary piston 122a is also inserted into corresponding pressure chambers 122, not visible in this view.

In the example actuator 100, each pressure chamber 122 includes a seal assembly 124 about the interior surface of the pressure chamber 122 at an open end 126. In some implementations, the seal assembly 124 can be a circular or semi-circular sealing geometry retained on all sides in a standard seal groove. In some implementations, commercially available reciprocating piston or cylinder type seals can be used. For example, commercially available seal types that may already be in use for linear hydraulic actuators flying on current aircraft may demonstrate sufficient capability for linear load and position holding applications. In some implementations, the sealing complexity of the actuator 100 may be reduced by using a standard, e.g., commercially available, semi-circular, unidirectional seal designs generally used in linear hydraulic actuators. In some embodiments, the seal assembly 124 can be a one-piece seal.

In some embodiments of the example actuator 100, the seal assembly 124 may be included as part of the rotary pistons 112a, 112b. For example, the seal assembly 124 may be located near the piston end 113, opposite the connector arm 115, and slide along the interior surface of the pressure chamber 122 to form a fluidic seal as the rotary piston 112a or 112b moves in and out of the pressure chamber 122. In some embodiments, the seal assembly 124 can act as a bearing. For example, the seal assembly 124 may provide support for the piston 112a, 112b as it moves in and out of the pressure chamber 122.

In some embodiments, the actuator 100 may include a wear member between the piston 112a, 112b and the pressure chamber 122. For example, a wear ring may be included in proximity to the seal assembly 124. The wear ring may act as a pilot for the piston 112a, 112b, and/or act as a bearing providing support for the piston 112a, 112b.

In the example actuator 100, when the rotary pistons 112a, 112b are inserted through the open ends 126, each of the seal assemblies 124 contacts the interior surface of the pressure chamber 122 and the substantially smooth surface of the piston end 113 to form a substantially pressure-sealed region within the pressure chamber 122. Each of the pressure chambers 122 may include a fluid port (not shown) formed through the pressure chamber assembly 120, through which pressurized fluid may flow. Upon introduction of pressurized fluid, e.g., hydraulic oil, water, air, or gas, into the pressure chambers 122, the pressure differential between the interior of the pressure chambers 122 and the ambient conditions outside the pressure chambers 122 causes the piston ends 113 to be urged outward from the pressure chambers 122. As the piston ends 113 are urged outward, the pistons 112a, 112b urge the rotary piston assembly 110 to rotate.

In some embodiments, the rotary pistons 112a, 112b may urge rotation of the rotor shaft 114 by contacting the rotor arm 116. For example, the connector arms 115 may not be coupled to the rotor arm 116. Instead, the connector arms 115 may contact the rotor arm 116 to urge rotation of the rotor shaft 114 as the rotary pistons 112a, 112b are urged outward from the pressure chambers 122. Conversely, the rotor arm 116 may contact the connector arms 115 to urge the rotary pistons 112a, 112b back into the pressure chambers 122.

In use, pressurized fluid in the example actuator 100 can be applied to the pressure chambers 122. The fluid pressure urges the rotary piston 112a out of the pressure chamber 122, and this movement urges the rotary piston assembly 110 to rotate clockwise. Pressurized fluid can be applied to the pressure chamber 122 corresponding to the rotary piston 122b, and the fluid pressure urges the rotary piston 112b out of the pressure chambers 122, urging the rotary piston assembly 110 to rotate counter-clockwise.

In some embodiments of the example actuator 100, the pressure chamber assembly 120 can be formed from a single piece of material. For example, the pressure chambers 122 and the openings 126 may be formed by molding, machining, or otherwise forming a unitary piece of material to form pressure chambers having no additional seams.

Referring now to FIGS. 1, 2A, and 2B, the actuator 100 includes a pair of housing end plates 134. The housing end plates 134 are removably attached to the axial ends of the pressure chamber assembly 120 by a collection of fasteners (not shown).

A bearing support assembly 130 is removably attached to the housing end plates 134 by a collection of fasteners 135. The bearing support assembly 130 includes a pair of bearing support plates 131a and 131b that extend radially beyond the housing end plates 134 and the rotary pistons 122a, 122b. The bearing support plates 131a, 131b include a collection of bearings 132 that rotate about axes that substantially align with the axis of the actuator 100 and the axis of the rotor shaft 114. In some embodiments, the bearing support plates 131a and/or 131b can be integral with (i.e., part of) the housing end plates 134.

A torque output intensifier (TOI) 150a and a torque output intensifier (TOI) 150b extend across a gap 136 between the bearing support plates 131a and 131b. The TOIs 150a and 150b each include a cylindrical roller portion 151 supported at a lengthwise end by a shaft portion 152. Each end portion 153 of each shaft portion 152 is rotationally supported by a corresponding one of the bearings 132. In the illustrated configuration, the TOIs 150a and 150b rotate about axes that are substantially parallel to the axis of the actuator 100 and the axis of the rotor shaft 114, and rotate substantially perpendicular to the paths of motion of the rotary pistons 112a and 112b.

The TOIs 150a and 150b are arranged such that their roller portions 151 contact the piston ends 113 of the rotary pistons 112a and 112b. In the illustrated configuration, the TOIs 150a and 150b can at least partly constrain radial movement of the rotary pistons 112a and 112b. For example, with reference to FIG. 2B, the rotary piston assembly 110 is shown rotated to a clockwise position near one end of its range of rotational motion. In such an orientation of the rotary piston 112b, the length of the piston end 113 that extends between the connector pin 118 (e.g., a first point of contact) and the seal assembly 124 of the pressure chamber 122 (e.g., a second point of contact) is relatively short and offers a relatively small moment arm. In such orientations, the opportunity for forces to act upon the rotary piston 112b in directions other than the orbital rotary path of motion is relatively small.

But as the piston assembly 110 and the rotary piston 112b are rotated counter-clockwise, the length of the piston end 113 that extends between the connector pin 118 and the seal assembly 124 becomes relatively longer and offers a relatively longer moment arm. As the rotary piston 112b extends (e.g., beyond rotations of about 80 degrees), the opportunity for forces to act upon the rotary piston 112b in directions other than the orbital rotary path (e.g., radial forces) can increase. In the example of the assembly 100, the TOIs 150a and 150b redirect outwardly radial forces acting upon the rotary pistons 112a, 112b, to at least partly transform such forces into forces that act substantially along the rotary pistons' 112a, 112b radial paths of motion.

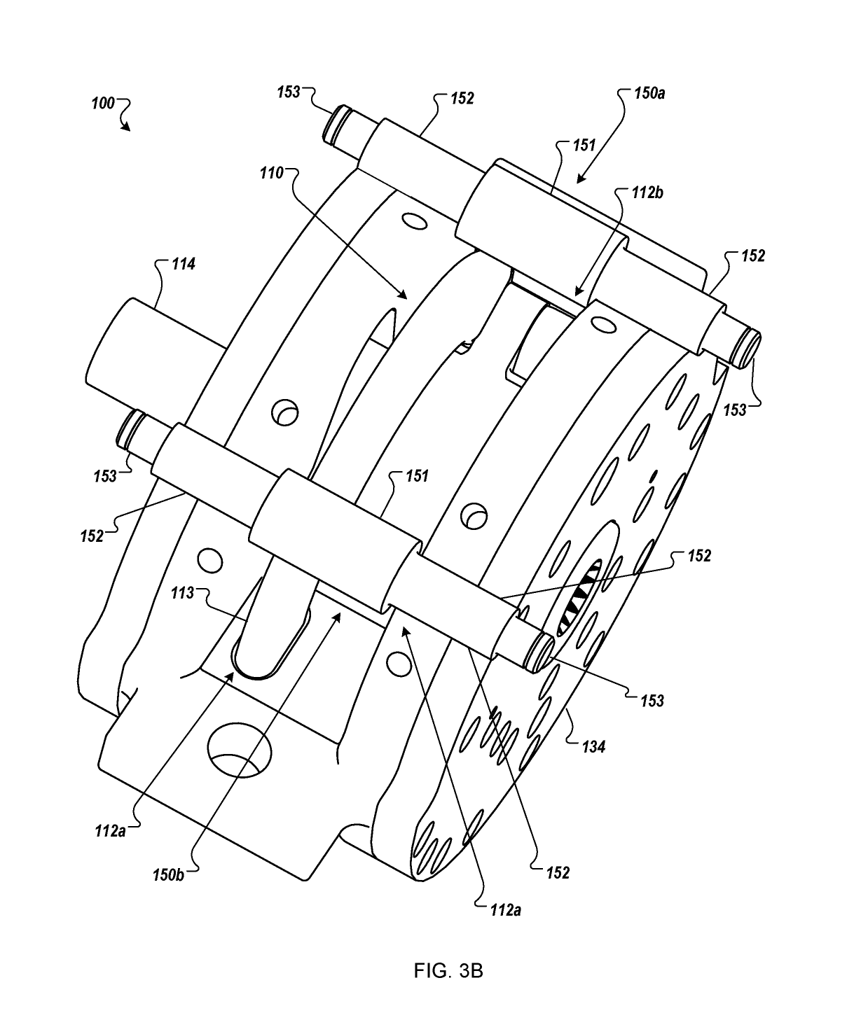

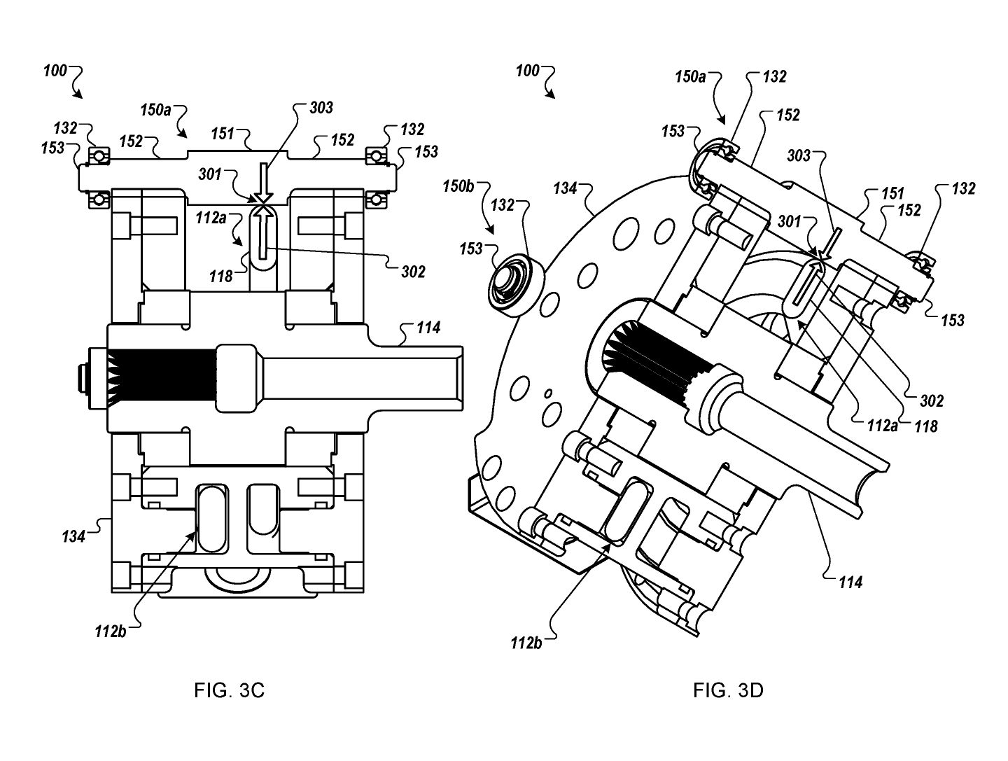

FIGS. 3A-3D are diagrams that show some more various views of the example rotary piston actuator 100 of FIGS. 1-2B. In FIGS. 3A-3D, the actuator 100 is shown with the bearing support assembly 130 removed to provide a clearer view of the mechanical interaction between the TOI's 150a, 150b, and the rotary pistons 112a, 112b.

The TOI's 150a and 150b are positioned relative to the rotary pistons 112a and 112b such that their roller portions 151 contact the piston ends 113. As shown in FIGS. 3C and 3D, the roller portion 151 of the TOI 150a contacts the piston end 113 of the rotary piston 112a at a point 301. In examples where the piston 112a is subjected to a radial force acting radially outward (e.g., away from the rotor shaft 114), as represented by the arrow 302, the piston end 113 may be urged radially outward. In such examples, the radial force 302 and the radial movement of the piston end 113 will encounter a substantially equal and opposite resistive force, represented by the arrow 303, provided by contact with the roller portion 151 at the point 301. As such, the radial force 302 and radial movement of the rotary piston 112a is at least partly constrained by the TOI 150a.

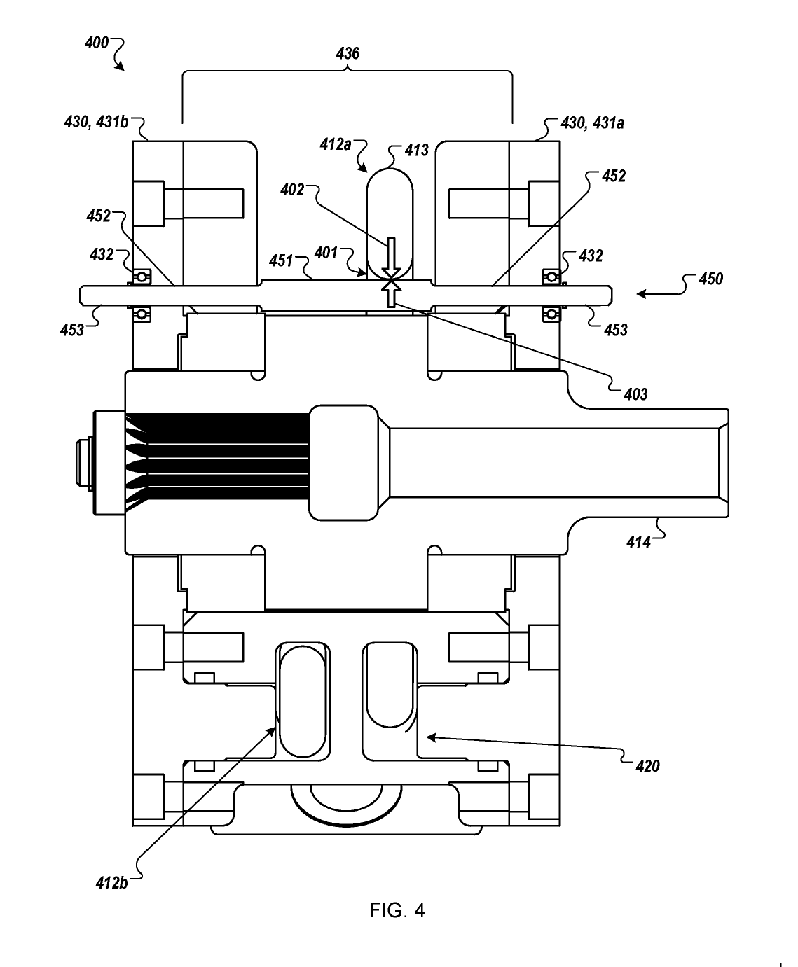

FIG. 4 is a sectional diagram that shows an example of a rotary piston-type actuator 400 and another example of a torque intensifier 450. In the examples of the rotary piston-type actuator 100 of FIGS. 1-3D, the torque output intensifiers 150a and 150b are located proximal the radially outward sides of the rotary pistons 112a and 112b. However, in the example of the actuator 400, a torque output intensifier 450 is arranged to contact the radially inward sides of rotary pistons.

The actuator 400 includes a first rotary piston 412a and a second rotary piston 412b. In the example of actuator 400, the first rotary piston 412a is configured to rotate a rotor shaft 414 in a first direction, e.g., clockwise, and the second rotary piston 412b is configured to rotate the rotor shaft 414 in a second direction substantially opposite the first direction, e.g., counter-clockwise.

Each of the rotary pistons 412a, 412b includes a piston end 413 and one or more connector arms (not shown). The piston end 413 is formed to have a substantially smooth surface. The rotary pistons 412a and 412b are inserted into a corresponding pressure chamber formed as an arcuate cavity in a pressure chamber assembly 420.

A bearing support assembly 430 includes a pair of bearing support plates 431a and 431b that extend radially beyond the housing end plates 434 and the rotary pistons 422a, 422b. The bearing support plates 431a, 431b include a collection of bearings 432 that rotate about axes that substantially align with the axis of the actuator 400 and the axis of the rotor shaft 414.

The torque output intensifier (TOI) 450 extends across a gap 436 between the bearing support plates 431a and 431b. The TOI 450 includes a cylindrical roller portion 451 extending radially from a shaft portion 452. The shaft portion 452 has a pair of end portions 453 that are rotationally supported by a corresponding bearing 432. In the illustrated configuration, the TOI 450 rotates about an axis that is substantially parallel to the axis of the actuator 400 and the axis of the rotor shaft 414, and rotates substantially perpendicular to the paths of motion of the rotary pistons 412a and 412b.

The TOI 450 is arranged such that the roller portion 451 contacts a piston end 413 of the rotary piston 412a. In the illustrated configuration, the TOI 450 can at least partly constrain inward radial movement of the rotary pistons 412a and 412b. The roller portion 451 of the TOI 450 contacts the piston end 413 of the rotary piston 412a at a point 401. In examples where the piston 412a is subjected to a radial force acting radially inward (e.g., toward the rotor shaft 414), as represented by the arrow 402, the piston end 413 may be urged radially inward. In such examples, the radial force 402 and the radial movement of the piston end 413 will encounter a substantially equal and opposite resistive force, represented by the arrow 403, provided by contact with the roller portion 451 at the point 401. As such, the radial force 402 and radial movement of the rotary piston 412a is at least partly constrained by the TOI 450.

In some embodiments, various combinations of radially inboard and/or outboard torque output intensifiers (e.g., the TOIs 150a, 150b, 450) may be used to at least partly constrain and/or redirect forces that are not aligned with the rotary paths of motion of the rotary pistons 112a, 112b, 412a, and/or 412b.

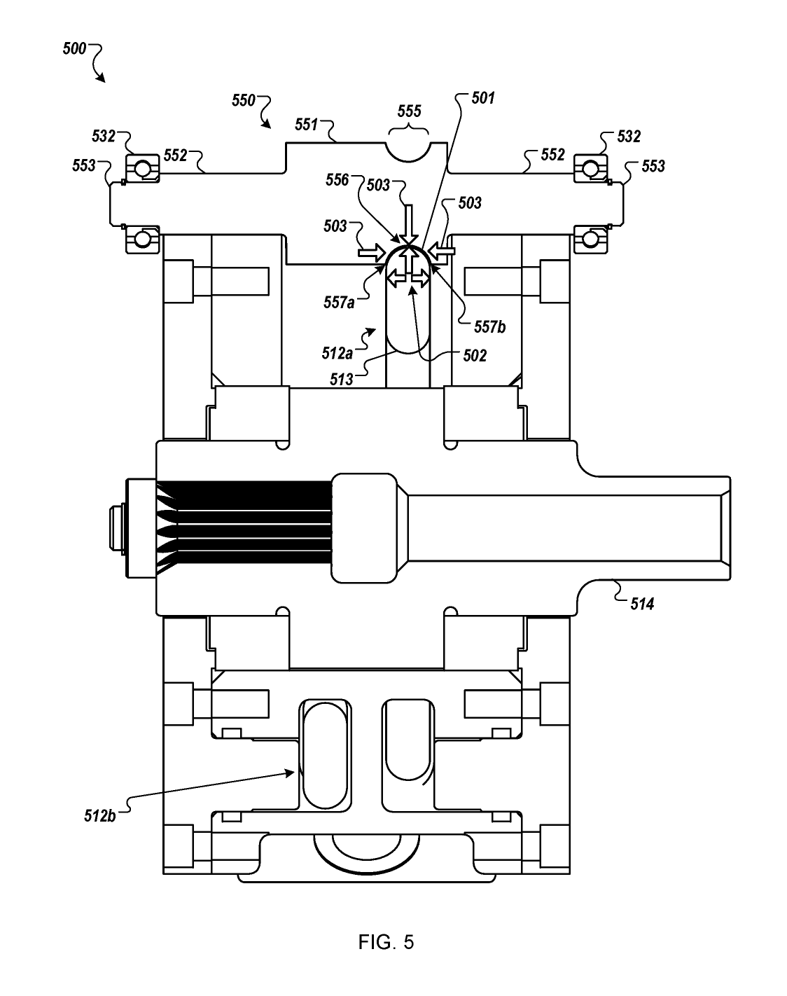

FIG. 5 is a sectional diagram that shows an example of a rotary piston actuator 500 and another example of a torque intensifier. In the examples of the rotary piston-type actuator 100 of FIGS. 1-3D and the rotary piston-type actuator 400 of FIG. 4, the torque output intensifiers 150a, 150b, and 450 have roller portions 151 and 451 that are substantially cylindrical. However, in the example of the actuator 500, a torque output intensifier 550 is includes a roller portion 551 that is contoured (e.g., scalloped, grooved) to resemble a bobbin.

The actuator 500 includes a first rotary piston 512a and a second rotary piston 512b. Each of the rotary pistons 512a, 512b includes a piston end 513 and one or more connector arms (not shown). The piston end 513 is formed to have a substantially smooth surface and an ovoid cross-section.

The TOI 550 includes the cylindrical roller portion 551 extending radially from a shaft portion 552. The shaft portion 552 has a pair of end portions 553 that are rotationally supported by a corresponding bearing 532. In the illustrated configuration, the TOI 550 rotates about an axis that is substantially parallel to the axis of the actuator 500 and the axis of a rotor shaft 514, and rotates substantially perpendicular to the paths of motion of the rotary pistons 512a and 512b.

The TOI 550 includes a radial groove 555 formed in the surface of the roller portion 551. The groove 555 is formed to complement a portion of the cross-section of the piston end 513. The TOI 550 is arranged such that the piston end 513 of the rotary piston 512a extends partly into the groove 555. In the illustrated configuration, the TOI 550 can at least partly constrain inward radial movement as well as axial lateral movement of the rotary pistons 512a and 512b. The groove 555 includes a radial end 556, an axial end 557a forming one axial sidewall of the groove 555, and an axial end 557b forming another axial sidewall of the groove 555 opposite the axial end 557a opposite the radial end 556. The groove 555 of the TOI 550 contacts the piston end 513 of the rotary piston 512a along a surface 501. In examples where the piston 512a is subjected to forces acting radially inward (e.g., toward the rotor shaft 514) and/or axially, as represented by the arrows 502, the piston end 513 may be urged radially inward and/or axially. In such examples, the forces 502 and the radial and/or axial movement of the piston end 513 will encounter substantially equal and opposite resistive forces, represented by the arrows 503, provided by contact with the groove 555 along the surface 501. As such, the forces 502 and radial and/or axial movement of the rotary piston 512a is at least partly constrained by the TOI 550.

In some embodiments, various combinations of radially inboard and/or outboard torque output intensifiers (e.g., the TOIs 550) may be used to at least partly constrain and/or redirect forces that are not aligned with the rotary paths of motion of the rotary pistons 512a, 512b. For example, the TOI 550 may be arranged radially inboard relative to the rotary piston 512a such that the groove 555 contacts the radially inward side of the piston end 513.

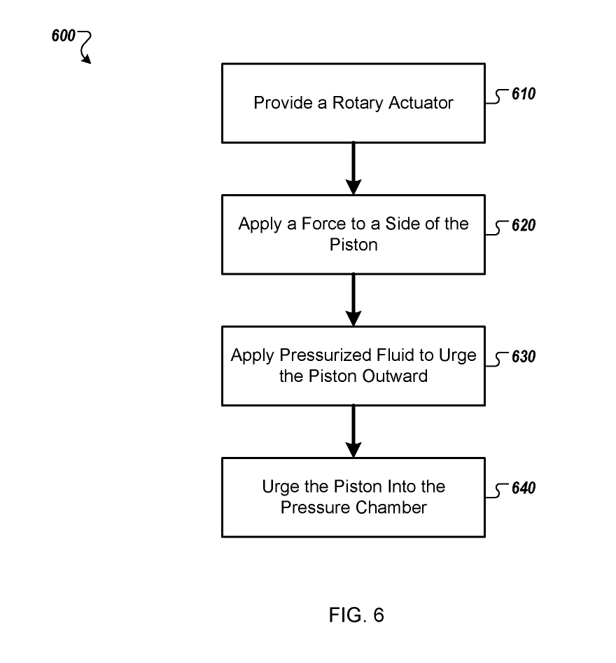

FIG. 6 is a flow diagram for an example process 600 for using a rotary piston actuator having a torque output intensifier (TOI). In some implementations, the process 600 can be used with the example rotary piston-type actuators 100, 400, and 500 of FIGS. 1-5.

At 610 a rotary actuator is provided. The rotary actuator of the example process 600 includes a housing defining an arcuate chamber comprising a cavity, a fluid port in fluid communication with the cavity, and an open end, the arcuate chamber following a portion of a first arc between a first end and a second proximal the open end. The rotary actuator also includes an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber. The rotary actuator also includes a first bearing in contact with a first radial side of the piston relative to the radius of curvature at a contact point beyond the first arc. For example, the rotary actuator 100 includes the TOIs 150a and 150b in contact with radially outboard sides the rotary pistons 112a and 112b.

At 620, a first radial force is applied by the bearing to the first radial side of the piston. For example, the TOI 150a contacts the rotary piston 112a to apply the force 303 to the piston end 113 at the point 301.

At 630, pressurized fluid is applied at the fluid port to urge the piston partially outward from the first pressure chamber. For example, fluid can be pumped into the pressure chamber 122 to urge the piston 112a out of the pressure chamber 122.

At 640, the piston is urged partially into the pressure chamber to urge pressurized fluid out the fluid port. For example, a torque can be applied to the rotor shaft 114 to urge the rotary piston 112a into the pressure chamber 122.

In some implementations, the first radial side can be a radially upper side. For example, the TOI 150a is arranged to contact the radial outside of the rotary piston 112a. In some implementations, applying the first radial force to the first radial side of the piston can include constraining a radially outward force of the piston. For example, the TOI 150a can at least partly constrain radially outward movement of the piston end 113 of the rotary piston 112a.

In some implementations, the first radial side can be a radially lower side. For example, the TOI 450 of the example actuator 400 of FIG. 4 is arranged to contact the radial underside of the rotary piston 412a. In some implementations, applying the first radial force to the first radial side of the piston can include constraining a radially inward force of the piston. For example, the TOI 450 can contact the rotary piston 412 on a radially inner or bottom side of the rotary piston 412 to at least partly constrain radially inward forces acting upon the rotary piston 412.

In some implementations, the rotary actuator can also include a second bearing in contact with a second radial side of the piston opposite the first radial side. In some implementations, the method can also include applying, by the second bearing, a second radial force to the first radial side of the piston. For example, a rotary piston-type actuator (e.g., the actuator 100) can include both the TOI 150a contacting the rotary piston 112a on a radially outer or top side of the rotary piston 112a to constrain radially outward forces acting upon the rotary piston 112a, and the TOI 450 contacting the rotary piston 112a on a radially inner or bottom side of the rotary piston 112a to constrain radially inward forces acting upon the rotary piston 112a.

In some implementations, the first bearing can be a roller bearing. For example, the TOIs 150a, 150b, 450, and 550 can be roller bearings having a generally cylindrical shape.

In some implementations, the roller bearing can include a body portion configured to at least partly conform to the shape of the first radial side, and at least one end portion configured to at least partly conform to the shape of an axial side of the piston relative to the radius of curvature. For example, the TOI 550 of the example rotary piston-type actuator 500 includes the groove 555. The radial end 556 of the groove 555 in the roller portion 551 is flanked by the axial end 557a and the axial 557b such that the groove 555 partly conforms to the shape of the piston end 513 of the rotary piston 512a.

In some implementations, a first axial force can be applied to the axial side of the piston. For example, gravity, inertia, or other forces, can induce a force that is directed axially across the piston end 513 (e.g., axially relative to the orbit of the rotary piston 512 and/or substantially parallel to the axis of the TOI 550). In some implementations, applying the first axial force can include at least partly constraining an axial force of the piston. For example, the groove 555 includes the radial end 556 to provide radial support and constraint for the piston end 513, the groove 555 includes the axial end 557a to provide axial support and constraint on one axial side of the piston end 513, and the groove 555 includes the axial end 557b to provide axial support and constraint on the other axial side of the piston end 513.

In some embodiments, the first housing can be formed as a one-piece housing. For example, the pressure chamber assembly 120 of the example rotary piston-type actuator 100 can be a single, unitary piece of material (e.g., metal, plastic, ceramic), and the pressure chambers 122 can be machined, molded, or otherwise formed within the single, unitary piece of material such that the pressure chambers 122 substantially seamless.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A rotary actuator comprising:
a housing defining an arcuate chamber comprising a cavity, a fluid port in fluid communication with the cavity, and an open end, the arcuate chamber following a portion of a first arc between a first end and a second proximal the open end;
an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber; and
a first bearing in contact with a first radial side of the piston relative to the radius of curvature at a contact point beyond the first arc.

2. The rotary actuator of claim 1, further comprising a second bearing in contact with a second radial side of the piston opposite the first radial side.

3. The rotary actuator of claim 1, wherein the first radial side is a radially upper side.

4. The rotary actuator of claim 1, wherein the first radial side is a radially lower side.

5. The rotary actuator of claim 1, wherein the first bearing is a roller bearing.

6. The rotary actuator of claim 5, wherein the roller bearing comprises a body portion configured to at least partly conform to the shape of the first radial side, and at least one end portion configured to at least partly conform to the shape of an axial side of the piston relative to the radius of curvature.

7. The rotary actuator of claim 1, wherein the first housing is formed as a one-piece housing.

8. A method of rotary actuation comprising:
providing a rotary actuator comprising:
a housing defining an arcuate chamber comprising a cavity, a fluid port in fluid communication with the cavity, and an open end, the arcuate chamber following a portion of a first arc between a first end and a second proximal the open end;
an arcuate-shaped piston disposed in said housing for reciprocal movement in the arcuate chamber through the open end, the arcuate-shaped piston following a portion of a second arc having a radius of curvature, wherein a seal, the cavity, and the piston define a pressure chamber; and
a first bearing in contact with a first radial side of the piston relative to the radius of curvature at a contact point beyond the first arc;
applying, by the first bearing, a first radial force to the first radial side of the piston;
applying pressurized fluid out the fluid port to urge the piston partially outward from the first pressure chamber; and,
urging the piston partially into the pressure chamber to urge pressurized fluid out the fluid port.

9. The method of claim 8, wherein the rotary actuator further comprises a second bearing in contact with a second radial side of the piston opposite the first radial side, and the method further comprises applying, by the second bearing, a second radial force to the first radial side of the piston.

10. The method of claim 8, wherein the first radial side is a radially upper side, and wherein applying the first radial force to the first radial side of the piston comprises constraining a radially outward force of the piston.

11. The method of claim 8, wherein the first radial side is a radially lower side, and wherein applying the first radial force to the first radial side of the piston comprises constraining a radially inward force of the piston.

12. The method of claim 8, wherein the first bearing is a roller bearing.

13. The method of claim 12, wherein the roller bearing comprises a body portion configured to at least partly conform to the shape of the first radial side, and at least one end portion configured to at least partly conform to the shape of an axial side of the piston relative to the radius of curvature.

14. The method of claim 13, further comprising applying a first axial force to the axial side of the piston.

15. The method of claim 14, wherein applying the first axial force comprises constraining an axial force of the piston.

16. The method of claim 8, wherein the first housing is formed as a one-piece housing.
